(19) United States
(12) Patent Application Publication
(10) Pub. No.: US 2011/0191089 A1
(43) Pub. Date: Aug. 4, 2011

(54) METHOD AND APPARATUS FOR MONITORING DEMANDS IN A NUMBER OF MODELS OF A SYSTEM

(76) Inventor: Anjelika Votintseva, Ottobrunn (DE)

(21) Appl. No.: 13/062,746

(22) PCT Filed: Jul. 23, 2009
(86) PCT No.: PCT/EP2009/059481

§ 371 Date: Apr. 6, 2011

(30) Foreign Application Priority Data
Sep. 17, 2008 (DE) 10 2008 047 578.5

(51) Int. Cl. G06F 17/50

(52) U.S. Cl. 703/13

(57) ABSTRACT

The method involves relationships or dependencies between two demands within the models being tracked and being able to be stored for later use. A structured request is used to search for at least one relationship between two demands within a definable search space. The request is equipped with a source phrase having a stipulated first structural element, a destination phrase having a stipulated second structural element and a result element with a stipulated name for the pair comprising the source phrase and the destination phrase and with a stipulated relationship type. Consequently, the demand monitoring by the structural elements is very flexible. The flexibility is increased further by the possibility of storing and managing the result element with the created relationship or the created relationships independently of the models.

### CROSS-REFERENCE TO RELATED APPLICATIONS

This application is a U.S. National Stage Application of International Application No. PCT/EP2009/059481 filed Jul. 23, 2009, which designates the United States of America, and claims priority to DE Application No. 10 2008 047 578.5 filed Sep. 17, 2008. The contents of which are hereby incorporated by reference in their entirety.

### TECHNICAL FIELD

The invention relates to a method and apparatus for tracking requirements in a number of models of a system.

The technical field of the invention relates to the tracking of requirements and at the same time in particular to the tracking of mutual dependency or relationships.

### BACKGROUND

Requirements of a system are often used in different models, for example by a design team, a development team and a management team. The different models are also used at different times and are at the same time frequently modified. Thus, requirements or different requirements in different models are also subject to a not insignificant probability of change or revision.

There is moreover also the possibility of individual requirements being combined into more complex requirements within a model.

Requirements are often described in textual form in the various models. Because of this and as a result of the possible revisions of the requirements, analysis of a system comprising a plurality of different models is often difficult or at least very costly. Because of this difficulty and the high outlay such analyses are susceptible to error and frequently also incomplete.

### SUMMARY

According to various embodiments, requirements in a plurality of models of a system can be tracked automatically.

According to further embodiments, requirements in a plurality of models of a system can be tracked automatically in order to create relationships or dependencies between two or more requirements and in particular store these for further use.

According to an embodiment, a method of tracking requirements in a number of models of a system, may comprise the steps:
a) Provide a number of models of the system, wherein the respective model comprises a number of requirements;
b) Provide at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) Determine a search area within the number of models;
d) Search for all pairs of the source phrase and the target phrase of the respective structured request in the determined search area; and
e) Create a respective relationship between two requirements comprising the respective pair by means of the defined name for the respective pair and the respective defined relationship type.

According to a further embodiment, the respective relationship between two requirements comprising the respective pair can be created if the one requirement comprises the source phrase and the other requirement comprises the target phrase. According to a further embodiment, the respective requirement can be configured with a number of model elements, with at least one attribute and with at least one requirement description. According to a further embodiment, the number of model elements may comprise various model element categories. According to a further embodiment, the various model element categories may comprise: a first model element category comprising a number of structure model elements, a second model element category comprising a number of behavior model elements, a third model element category comprising a number of relationship model elements, and/or a fourth model element category comprising a number of extension model elements. According to a further embodiment, the search area within the number of models can be determined by means of a selection of at least one of the various model element categories. According to a further embodiment, the number of structure model elements may comprise various structure model element types and/or the number of behavior model elements comprises various behavior model element types and/or the number of relationship model elements comprises various relationship model element types and/or the number of extension model elements comprises various extension model element types. According to a further embodiment, the search area within the number of models can be determined by means of a selection of at least one model element type of the model elements. According to a further embodiment, a vocabulary can be formed by a number of vocabulary elements for describing the number of model elements and the requirement descriptions. According to a further embodiment, the vocabulary can be formed by a number of vocabulary categories, wherein predeterminable vocabulary elements are assigned to a respective vocabulary category. According to a further embodiment, the vocabulary can be disposed outside of the number of models and/or the vocabulary is configured as a plurality of glossaries, wherein the respective glossary is formed from at least one subset of the vocabulary and assigned to a respective model. According to a further embodiment, the first structure element can be configured in such a way that it comprises at least one term, and/or the second structure element is configured in such a way that it comprises at least one term. According to a further embodiment, the respective term can be formed from at least one vocabulary element of the vocabulary and/or from at least one term or expression that is freely selectable by a user. According to a further embodiment, the respective term can be formed from a sequence, freely selectable by the user, of at least one vocabulary element and/or a freely selectable term or expression and additionally from at least one character that is freely selectable by the user. According to a further embodiment, the respective vocabulary element can be configured as a descriptor of a modeling language used for the modeling of the number of models. According to a further embodiment, the respective descriptor may represent an expression, a term or a word of the requirement description or a name of a model element. According to a further embodiment, at least one vocabulary category can be selected for the respective term of the first and/or second structure element in order to limit the search in the determined search area. According to a further embodiment, in the result element an accuracy element can be provided, which is capable of limiting the search in the determined search area in dependence upon an accuracy value for the accuracy element that is determinable by a user. According to a further embodiment, the respective relationship created between two requirements comprising the respective pair by means of the defined name for the respective pair and the respective defined relationship type can be provided in the provided result element.

According to another embodiment, a computer program product may causes the implementation of a method as described above on a program-controlled device.

According to yet another embodiment, an apparatus for tracking requirements in a number of models of a system, may comprise
a) A first provision means, which is capable of providing a number of models of the system, wherein the respective model comprises a number of requirements;
b) A second provision means, which is capable of providing at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) A determination means, which is capable of determining a search area within the number of models;
d) A search means, which is capable of searching for all pairs of the source phrase and the target phrase of the respective structured request in the determined search area; and
e) A creation means, which is capable of creating a respective relationship between two requirements comprising the respective pair by means of the defined name for the respective pair.

### BRIEF DESCRIPTION OF THE DRAWINGS

There now follows a detailed description of the invention by way of embodiments that are indicated in the schematic figures. These show:

FIG. 1 a schematic sequence diagram of an embodiment of a method of tracking requirements in a number of models of a system;

FIG. 2 a schematic block diagram of an embodiment of a number of models of a system provided in accordance with step X1 of FIG. 1;

FIG. 3 a schematic block diagram of an embodiment of a structured request provided in accordance with step X2 of FIG. 1;

FIG. 4 a schematic block diagram of an embodiment of a search area determined in accordance with method step X3 of FIG. 1;

FIG. 5 a schematic block diagram of an embodiment of a search for all pairs in dependence upon the provided request in accordance with method step X4 of FIG. 1 and a relationship between two requirements created in dependence thereon in accordance with method step X5 of FIG. 1;

FIG. 6 a schematic block diagram of an embodiment of a requirement;

FIG. 7 a schematic block diagram of an embodiment of a requirement and a vocabulary;

FIG. 8 a schematic block diagram of an embodiment of a plurality of various model element categories;

FIG. 9 a schematic block diagram of an embodiment of an arrangement comprising a plurality of models, a plurality of glossaries and a vocabulary; and

FIG. 10 a schematic block diagram of an embodiment of an apparatus for tracking requirements in a number of models of a system.

### DETAILED DESCRIPTION

A method of tracking requirements in a number of models of a system is accordingly proposed, which comprises the following steps:
a) Provide a number of models of the system, wherein the respective model comprises a number of requirements;
b) Provide at least one structured request to search for at least one relationship between two requirements having a source phrase with a defined first structure element, a target phrase with a defined structure element and a result element with a defined name for the pair of source phrase and target phrase and a defined relationship type of the at least one relationship;
c) Determine a search area within the number of models;
d) Search for all pairs of the source phrase and the target phrase of the respective structured request in the determined search area; and
e) Create a respective relationship between two requirements comprising the respective pair by means of the defined name for the respective pair and the respective defined relationship type.

An apparatus for tracking requirements in a number of models of a system is further proposed, comprising:
a) A first provision means, which is capable of providing a number of models of the system, wherein the respective model comprises a number of requirements;
b) A second provision means, which is capable of providing at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) A determination means, which is capable of determining a search area within the number of models;
d) A search means, which is capable of searching for all pairs of the source phrase and target phrase of the respective structured request in the determined search area; and
e) A creation means, which is capable of creating a respective relationship between two requirements comprising the respective pair by means of the defined name for the respective pair.

An advantage of the various embodiments is that requirements may also be tracked automatically in a plurality of models of a system.

In this case it is particularly advantageous that according to the various embodiments relationships or dependencies between two requirements may be created and also stored for subsequent use.

Furthermore, the tracking according to various embodiments of the requirements by means of the definable structure elements, namely the first structure element, the second structure element and the result element, is very flexible.

The flexibility of the various embodiments is further enhanced by the possibility of storing and managing the result element with the at least one created relationship or the created relationships independently of the models.

To search for the pairs, conventional search methods or trace retrieval algorithms may be used. An example of such a trace retrieval algorithm is to be found in “Modern Information Retrieval AACM Press)”, Ricardo Baeza-Yates and Berthier Ribiero-Neto, Addison-Wesley, 1999, chapter 8, Indexing and Searching, p. 191-229.

The models for the system may be created for example by means of one of the following modulating languages: UML, SysML, SCADE, Simulink or DSLs.

According to an embodiment the respective relationship between two requirements comprising the respective pair is created if the one requirement comprises the source phrase and the other requirement comprises the target phrase.

According to a further embodiment the respective requirement is configured with a number of model elements, with at least one attribute and with at least one requirement description.

According to a further embodiment the number of model elements comprises various model element categories.

According to a further embodiment the various model element categories comprise:
A first model element category comprising a number of structure model elements,
A second model element category comprising a number of behavior model elements,
A third model element category comprising a number of relationship model elements, and/or
A fourth model element category comprising a number of extension model elements.

According to a further embodiment the search area within the number of models is determined by means of a selection of at least one of the various model element categories.

According to a further embodiment the number of structure model elements comprises various structure model element types and/or the number of behavior model elements comprises various behavior model element types and/or the number of relationship model elements comprises various relationship model element types and/or the number of extension model elements comprises various extension model element types.

Examples of model element types in UML are: class, object, attribute, operation, relationship relation, generalization relation, interface, dependency relation, package, application, actuator, component, action etc. Examples of model element types in SysML are block, data type, part, block property, requirement, test case, standard port, flow port, allocation and the like. Examples of model element types in SCADE are type, interface, operator, variable, constant, status and the like. Examples of model element types in Simulink: subsystem block, input port, output port, signal, connection line and the like.

According to a further embodiment the search area within the number of models is determined by means of a selection of at least one model element type of the model elements.

According to a further embodiment a vocabulary is formed by a number of vocabulary elements for describing the number of model elements and the requirement descriptions.

According to a further embodiment the vocabulary is formed by a number of vocabulary categories, wherein predeterminable vocabulary elements are assigned to a respective vocabulary category.

According to a further embodiment the vocabulary is disposed outside of the number of models. Alternatively or additionally, the vocabulary is configured preferably as a plurality of glossaries, wherein the respective glossary is formed from at least one subset of the vocabulary and assigned to a respective model.

According to a further embodiment the first structure element is configured in such a way that it comprises at least one term, and/or the second structure element is configured in such a way that it comprises at least one term.

According to a further embodiment the respective term is formed from at least one vocabulary element of the vocabulary and/or from at least one term or expression that is freely selectable by a user.

According to a further embodiment the respective term is formed from a sequence, freely selectable by the user, of at least one vocabulary element and/or a freely selectable term or expression and in addition from at least one character that is freely selectable by the user.

According to a further embodiment the respective vocabulary element is configured as a descriptor of a modeling language used for the modeling of the number of models.

According to a further embodiment the respective descriptor represents an expression, a term or a word of the requirement description or a name of a model element.

According to a further embodiment at least one vocabulary category is selected for the respective term of the first and/or second structure element in order to limit the search in the determined search area.

According to a further embodiment, in the result element an accuracy element is provided, which is capable of limiting the search in the predetermined search area in dependence upon an accuracy value for the accuracy element that is determinable by a user.

According to a further embodiment the respective relationship created between two requirements comprising the respective pair by means of the defined name for the respective pair and the respective defined relationship type is provided in the provided result element.

A computer program product is further proposed, which causes the implementation of a method according to various embodiments as described above on a program-controlled device.

A computer program product such as a computer program means may be provided or supplied for example as a storage medium, such as a memory card, USB stick, floppy, CD-ROM, DVD, or alternatively in the form of a downloadable file by a server in a network. This may be done for example in a wireless communications network by transferring a corresponding file having the computer program product or the computer program means.

In all of the figures—unless indicated otherwise—identical and/or functionally identical means and devices are provided with the same reference characters.

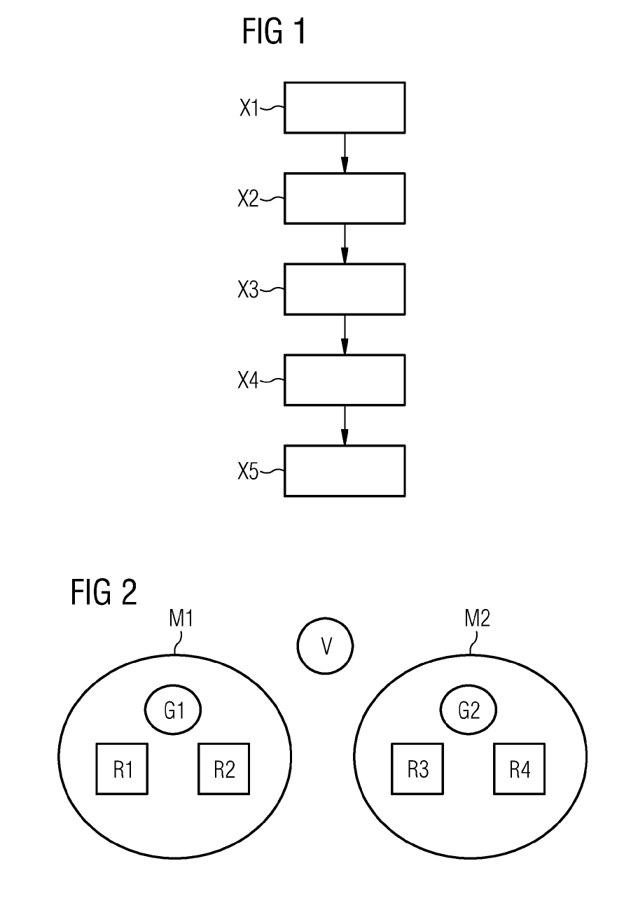

FIG. 1 shows a schematic sequence diagram of an embodiment of a method of tracking requirements R1-R4 in a number of models M1, M2 of a system.

There now follows a description of the method according to various embodiments on the basis of the block diagram in FIG. 1 with reference to FIGS. 2-9. The embodiment of the method according to FIG. 1 comprises the method steps X1-X5.

### Method Step X1:

A number of models M1, M2 of the system are provided. The respective model M1, M2 comprises a number of requirements R1-R4. In this regard, FIG. 2 shows a schematic block diagram of an embodiment of the number of models M1, M2 of the system that are provided in accordance with step X1 of FIG. 1. Without limiting the generality, a first model M1 comprises two requirements R1 and R2. A second model M2 may likewise comprise two requirements R3 and R4.

FIG. 2 further shows that a glossary G1, G2 is assigned to each model M1 and/or M2. According to FIG. 2 a vocabulary V is further provided. The functionalities of the glossaries G1, G2 and the vocabulary V are described in detail below.

### Method Step X2:

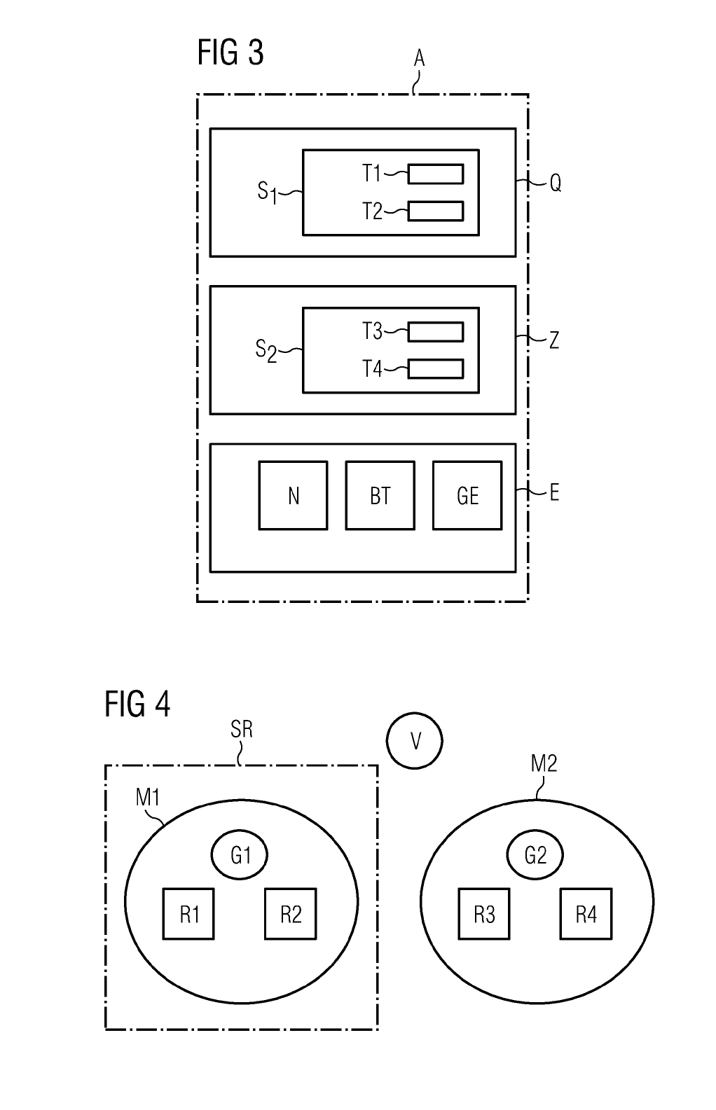

At least one structured request A to search for at least one relationship B (see FIG. 5) between two requirements R1-R4 having a source phrase Q with a defined first structure element S1, a target phrase Z with a defined second structure element S2 and a result element E with a defined name N for the pair Q, Z of source phrase Q and target phrase Z and a defined relationship type BT of the at least one relationship is provided. In this regard, FIG. 3 shows a schematic block diagram of an embodiment of such a structured request A provided in accordance with step X2 of FIG. 1.

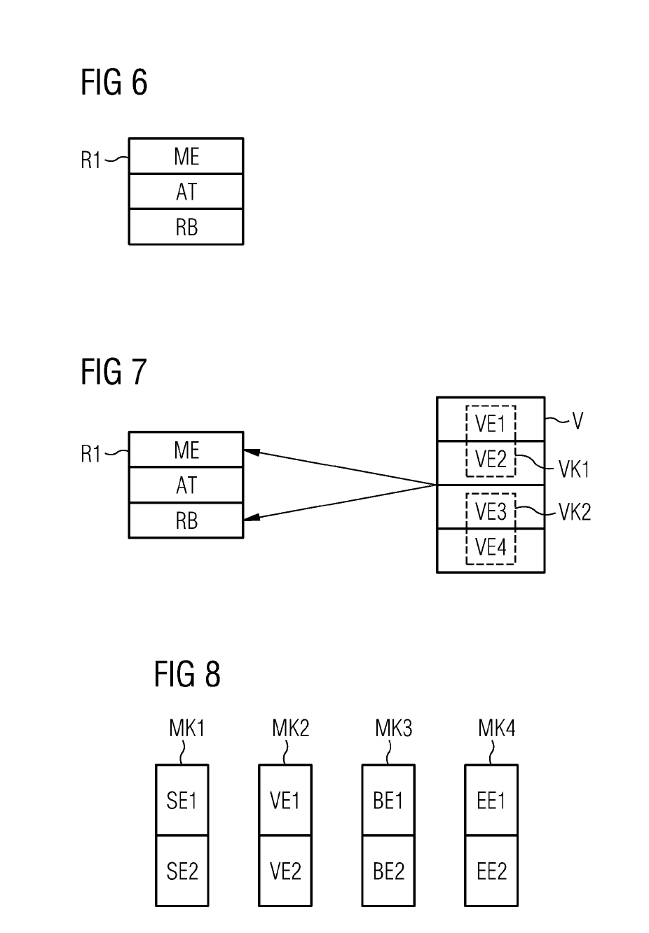

In this connection FIG. 6 shows a schematic block diagram of an embodiment of a requirement R1. Without restricting the generality, only one requirement R1 is represented in FIG. 6. The further requirements R2-R4 according to FIG. 2 may be configured in an analogous manner. The requirement R1 according to FIG. 6 has a number of model elements ME, at least one attribute AT and at least one requirement description RB for describing the requirement R1.

FIG. 7 further shows a schematic block diagram of an embodiment of such a requirement R1 and a vocabulary V. The requirement R1 is configured for example as in FIG. 6. The vocabulary V is formed preferably by a number of vocabulary elements VE1-VE4 for describing the number of model elements ME and the requirement descriptions RB. The vocabulary elements VE1-VE4 are preferably assigned to various vocabulary categories VK1, VK2. Without limiting the generality, according to FIG. 7 the vocabulary elements VE-, VE2 are assigned to a first vocabulary category VK1 and the vocabulary elements VE3, VE4 are assigned to a second vocabulary category VK2.

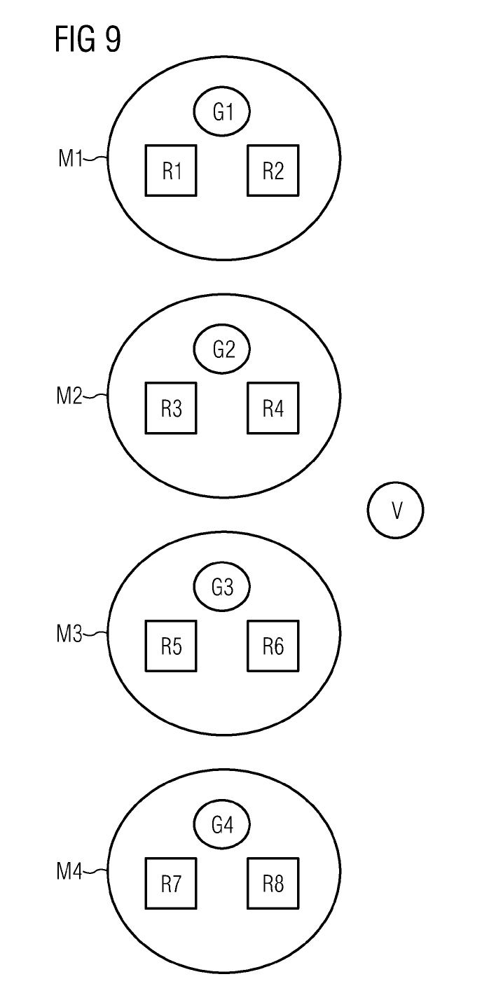

As shown in FIG. 2, the vocabulary V may be disposed outside of the number of models M1, M2. Additionally or alternatively, the vocabulary V may be configured as a plurality of glossaries G1-G4, wherein the respective glossary G1-G4 is formed from at least one subset of the vocabulary V and assigned to a respective model M1-M2. An example of a refinement of such an arrangement having a plurality of models M1-M4 a plurality of glossaries G1-G4 and a vocabulary V is represented in FIG. 9.

FIG. 8 further shows a schematic block diagram of an embodiment of a plurality of various model element categories MK1-MK4. Without limiting the generality, four model element categories MK1-MK4 are represented in FIG. 8.

The various model element categories comprise for example:
A first model element category MK1 comprising a number of structure model elements SE1, SE2 (without limiting the generality, two structure model elements SE1, SE2 are represented in FIG. 8),
A second model element category MK2 comprising a number of behavior model elements VE1, VE2,
A third model element category MK3 comprising a number of relationship model elements BE1, BE2, and
A fourth model element category MK4 comprising a number of extension model elements EE1, EE2.

The various structure model elements SE1, SE2 preferably further comprise various structure model element types. Equally, the number of various behavior model elements VE1, VE2 may comprise various behavior model element types. Analogously, the number of relationship model elements BE1, BE2 may comprise various relationship model element types. Alternatively or additionally, the number of extension model element types EE1, EE2 preferably comprises various extension model element types.

With reference to FIGS. 3 and 5 the first structure element S1 comprises at least one term T1, T2. The second structure element S2 analogously preferably comprises at least one term T3, T4.

The respective term T1-T4 or expression or textual expression is preferably formed from at least one vocabulary element VE1-VE2 of the vocabulary V and/or at least one term or expression that is freely selectable by a user.

For example, the respective term T1-T4 is formed from a sequence, freely selectable by the user, of at least one vocabulary element VE1-VE4 and/or a freely selectable term or expression and in addition from at least one character that is freely selectable by the user, such as for example “+”, “−”, “?”, “!”, any desired character of the keyboard or any desired special character. The respective vocabulary element VE1-VE4 is moreover configured in particular as a descriptor of a modeling language used to model the number of models M1, M2. The respective descriptor in this case preferably represents an expression, a term or a word of the requirement description RB or a name of a model element ME.

### Method Step X3:

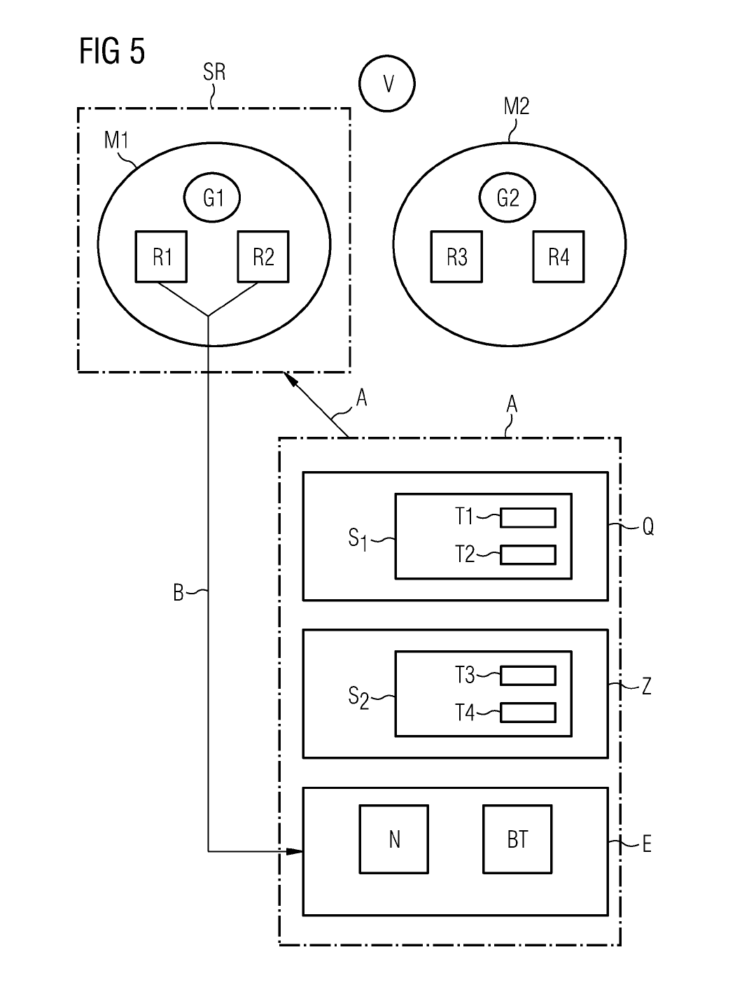

A search area SR is determined within the number of models M1, M2. In this regard, FIG. 4 shows a schematic block diagram of an embodiment of a search area SR determined in accordance with step X3 of FIG. 1.

For example, the search area SR within the number of models M1, M2 is determined by means of a number of the various model element categories MK1-MK4.

Alternatively or additionally, the search area SR within the number of models M1, M2 is determined by means of a selection of at least one model element type of the model elements ME.

Furthermore, preferably at least one vocabulary category VK is selected for the respective term T1-T4 of the first and/or second structure element S1, S2 in order to limit the search in the determined search area SR.

In this regard, FIG. 5 shows a schematic block diagram of an embodiment of a search for all pairs Q, Z of the source phrase Q and the target phrase Z in dependence upon the provided request A in accordance with step X4 in FIG. 1 and a relationship B, created in dependence thereon, between two requirements R1, R2 in accordance with step X5 of FIG. 1.

### Method Step X4:

All pairs Q, Z of the source phrase Q and the target phrase Z of the respective structured request A are searched for in the determined search area SR.

### Method Step X5:

A respective relationship B between two requirements R1-R4 comprising the respective pair Q, Z is created by means of the defined name N for the respective pair Q, Z and the respective defined relationship type BT. The respective relationship B between the two requirements R1-R4 comprising the respective pair Q, Z created by means of the defined name N for the respective pair Q, Z and the respective relationship type BT is preferably provided in the provided result element E.

In particular, the respective relationship B between two requirements R1-R4 comprising the respective pair Q, Z is created if the one requirement R1 comprises the source phrase Q and the other requirement R2 comprises the target phrase Z. The assignment of the source phrase Q to the first requirement R1 and of the target phrase Z to the second requirement R2 is purely by way of example.

The result element E moreover preferably comprises an accuracy element GE. The accuracy element GE is capable of limiting the search in the predetermined search area SR in dependence upon an accuracy value for the accuracy element E that is determinable by a user. For example, the accuracy value may be set to 80%, with the result that only pairs Q, Z having a relationship B with a probability of more than 80% are displayed as result pairs E.

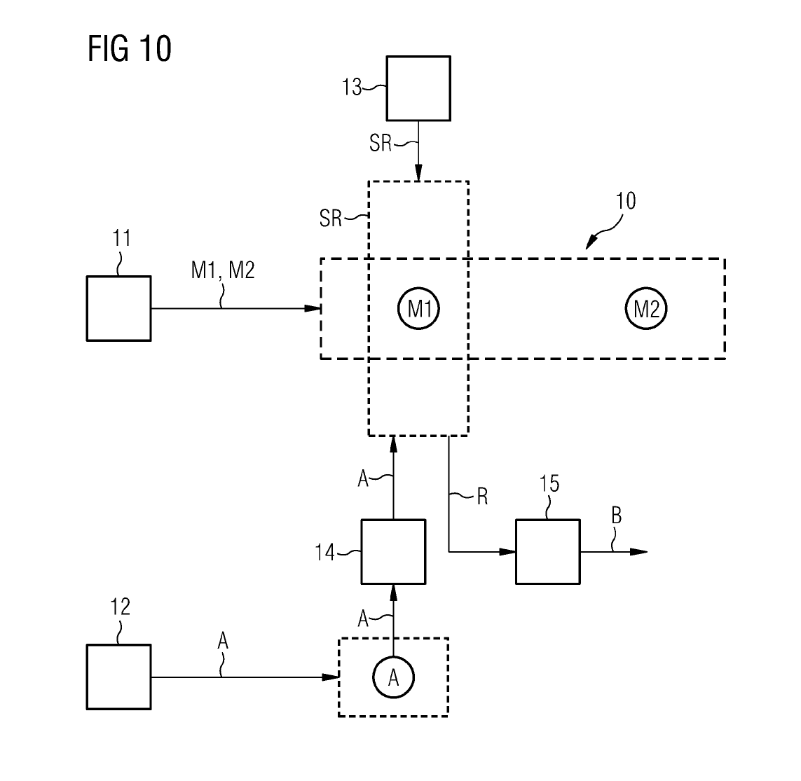

FIG. 10 shows a schematic block diagram of an embodiment of an apparatus 10 for tracking requirements R1-R4 in a number of models M1, M2 of a system.

The apparatus 10 according to various embodiments according to FIG. 10 comprises a first provision means 11, a second provision means 12, a determination means 13, a search means 14 and a creation means 15.

The first provision means 11 is capable of providing a number of models M1, M2 of the system, wherein the respective model M1, M2 comprises a number of requirements R1-R4 (see FIG. 2).

The second provision means 12 is capable of providing at least one structured request A to search for at least one relationship B between two requirements R1-R4 having a source phrase Q with a defined first structure element S1, a target phrase Z with a defined second structure element S2 and a result element E with a defined name N for the pair Q, Z of source phrase Q and target phrase Z and a defined relationship type of the at least one relationship B (see FIG. 2).

The determination means 13 is moreover capable of determining a search area SR within the number of models M1m M2 (see FIG. 3).

The search means 14 is further capable of searching for all pairs Q, Z of the source phrase Q and the target phrase Z of the respective structured request A in the determined search area SR.

The creation means 15 is moreover capable of creating a respective relationship B between two requirements R1-R4 comprising the respective pair Q, Z by means of the defined name N for the respective pair Q, Z found by the search means 14.

The respective means 11-15 may be implemented by hardware or software.

In the case of hardware implementation, the respective means 11-15 may be configured as an apparatus, device or part of a system.

In the case of software implementation, the respective means 11-15 may be configured as a computer program product, as a function, as a routine, as part of a program code or as an executable object.

A computer program product such as a computer program means may be provided or supplied for example as a storage medium, such as a memory card, USB stick, floppy, CD-ROM, DVD, or alternatively in the form of a downloadable file by a server in a network. This may be done for example in a wireless communications network by transferring a corresponding file having the computer program product or the computer program means.

There is further shown below an example of a possible refinement, in which a tracking configuration TC may be represented as a tuple

TC=(Dom, Voc, Trace_{Conf})
Dom being a set of descriptions of the system, i.e. documents or models, which are to be compared and linked;
Voc being a subset of the vocabulary entries and categories of the vocabulary V together with the name of the model element type, which are to be used in the tracking;
Trace being a set of relationship definitions.

Trace⊂ {(Source, Target, Result),
Source, TargetεCond(Voc) describing specifications of conditions of the source phrase and the target phrase in the form of regular expressions;
ResultεKind×Cond(voc) being a specification of a result element or a result relationship;

Cond(Voc) being a set of regular expressions of the alphabet.
Voc∪{\?]∪Char, wherein Char is a set of character entries of a keyboard and \? Stands for any possible symbol;
   and wherein Kind={trace, deriveReq, copy, verify, satisfy, refine, generalDependency, association, generalization, . . . }.

(s_cond, t_cond, K, r_cond)εSource×Target×Kind×Cond(Voc) signifies a requirement with its description in accordance with the condition S_cond is linked to a requirement with the corresponding description, which is linked to the condition t_cond by the relationship of kind k and name r_cond. The results of the relationship generation are stored separately, namely as a list of tuples.

res=(sID, tID, kind, name, status, catgr):
sID being the full path of the source requirement together with its ID;
tID being the full path of the target requirement together with its ID;
kindε{trace, deriveReq, copy, verify, satisfy, refine, generalDependency, association, generalization, . . . },
nameεCond(Voc), defined by the result specification or result element Result_{Trace}
statusε{suspected, approved, declined, deprecated},
catgr being the category of the term name.

Although the present invention has been described above by way of the embodiments, it is not limited thereto but may be modified in many different ways.

What is claimed is:

1. A method of tracking requirements in a number of models of a system, comprising the steps:
a) Providing a number of models of the system, wherein the respective model comprises a number of requirements;
b) Providing at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) Determining a search area within the number of models;
d) Searching for all pairs of the source phrase and the target phrase of the respective structured request in the determined search area; and
e) Creating a respective relationship between two requirements comprising the respective pair by means of the defined name for the respective pair and the respective defined relationship type.

2. The method according to claim 1, wherein the respective relationship between two requirements comprising the respective pair is created if the one requirement comprises the source phrase and the other requirement comprises the target phrase.

3. The method according to claim 1, wherein the respective requirement is configured with a number of model elements, with at least one attribute and with at least one requirement description.

4. The method according to claim 3, wherein the number of model elements comprises various model element categories.

5. The method according to claim 4, wherein the various model element categories comprise at least one of:
a first model element category comprising a number of structure model elements,
a second model element category comprising a number of behavior model elements,
a third model element category comprising a number of relationship model elements, and/or
a fourth model element category comprising a number of extension model elements.

6. The method according to claim 4, wherein the search area within the number of models is determined by means of a selection of at least one of the various model element categories.

7. The method according to claim 4, wherein the method provides for at least one of:
the number of structure model elements comprises various structure model element types, and/or
the number of behavior model elements comprises various behavior model element types, end/or
the number of relationship model elements comprises various relationship model element types, and/or
the number of extension model elements comprises various extension model element types.

8. The method according to claim 7, wherein the search area within the number of models is determined by means of a selection of at least one model element type of the model elements.

9. The method according to claim 3, wherein a vocabulary is formed by a number of vocabulary elements for describing the number of model elements and the requirement descriptions.

10. The method according to claim 9, wherein the vocabulary is formed by a number of vocabulary categories, wherein predeterminable vocabulary elements are assigned to a respective vocabulary category.

11. The method according to claim 9, wherein the method provides for at least one of:
the vocabulary is disposed outside of the number of models and
the vocabulary is configured as a plurality of glossaries, wherein the respective glossary is formed from at least one subset of the vocabulary and assigned to a respective model.

12. The method according to claim 11, wherein the method provides for at least one of:
the first structure element is configured in such a way that it comprises at least one term, and
the second structure element is configured in such a way that it comprises at least one term.

13. The method according to claim 12, wherein the respective term is formed at least from one of at least one vocabulary element of the vocabulary and/or from at least one term or expression that is freely selectable by a user.

14. The method according to claim 13, wherein the respective term is formed from at least one of
a sequence, freely selectable by the user, of at least one vocabulary element and
a freely selectable term or expression, and
additionally from at least one character that is freely selectable by the user.

15. The method according to claim 9, wherein the respective vocabulary element is configured as a descriptor of a modeling language used for the modeling of the number of models.

16. The method according to claim 15, wherein the respective descriptor represents an expression, a term or a word of the requirement description or a name of a model element.

17. The method according to claim 13, wherein at least one vocabulary category is selected for the respective term of at least one of the first and/or second structure element in order to limit the search in the determined search area.

18. The method according to claim 1, wherein in the result element an accuracy element is provided, which is capable of limiting the search in the determined search area in dependence upon an accuracy value for the accuracy element that is determinable by a user.

19. The method according to claim 1, wherein the respective relationship created between two requirements comprising the respective pair by means of the defined name for the respective pair and the respective defined relationship type is provided in the provided result element.

20. A computer program product comprising a computer readable medium storing instructions which when executed on a program-controlled device perform the steps of:
a) Providing a number of models of the system, wherein the respective model comprises a number of requirements;
b) Providing at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) Determining a search area within the number of models;
d) Searching for all pairs of the source phrase and the target phrase of the respective structured request in the determined search area; and
e) Creating a respective relationship between two requirements comprising the respective pair by means of the defined name for the respective pair and the respective defined relationship type.

21. An apparatus for tracking requirements in a number of models of a system, comprising
a) A first provision means, which is capable of providing a number of models of the system, wherein the respective model comprises a number of requirements;
b) A second provision means, which is capable of providing at least one structured request to search for at least one relationship between two requirements having a source phrase with a defined first structure element, a target phrase with a defined second structure element and a result element with a defined name for the pair of source phrase and target phrase and a defined relationship type of the at least one relationship;
c) A determination means, which is capable of determining a search area within the number of models;
d) A search means, which is capable of searching for all pairs of the source phrase and the target phrase of the respective structured request in the determined search area; and
e) A creation means, which is capable of creating a respective relationship between two requirements comprising the respective pair by means of the defined name for the respective pair.
